(19) United States
(12) Patent Application Publication
(10) Pub. No.: US 2024/0246448 A1
(43) Pub. Date: Jul. 25, 2024

(54) EMERGENCY ON-BOARD EV CHARGER

(71) Applicants: Michael J Ayala, Canoga Park, CA (US); Raad Al-zoubi, Chatsworth, CA (US)

(72) Inventors: Michael J Ayala, Canoga Park, CA (US); Raad Al-zoubi, Chatsworth, CA (US)

(21) Appl. No.: 18/098,918

(22) Filed: Jan. 19, 2023

(51) Int. Cl. B60L 55/00; H02J 7/00

(52) U.S. Cl. CPC B60L 55/00; H02J 7/0045; H02J 7/007194; B60L 2210/40

(57) ABSTRACT

The present invention safely places an Emergency On-Board charger in the trunk of any EV in the market. When using it for one hour, it can extend the range depending on the EV. A modular and compact design that perfectly fits any EV and that is light enough to be carried around by a single person, and it only needs to be charged when used or each trimester. It has a smartphone app monitor system that allows the user to keep a track of the energy on the device, and several safety measures such as a sturdy case, Battery Management System (BMS), protection against overload, critical temperatures and short circuits, and fire extinguishers to ensure the safety of the customer.

### FIELD OF THE INVENTION

The present invention relates to portable EV chargers.

### BACKGROUND OF THE INVENTION

Global decarbonization efforts require the exponential transition from internal combustion engine vehicles (ICEs) to electric vehicles (EVs). According to an EV adoption estimate, US EVs in operation will be over 25 million units by 2030. As the tsunami of EVs approaches, the number of EV's users with low batteries increases with it, leaving thousands of EVs without power and with their brakes locked on the streets and highways all around the country.

If an EV battery is completely discharged to 0%, the electric vehicle will hopefully stop on the side of the road and not in the middle of the street. Since EV's operation relies 100% upon the power storage of its batteries, it'll not be attainable for the user to move the car because it has no energy left. Towing an EV is a more complex solution because the brakes lock when it doesn't detect power, this safety design makes it difficult to tow an EV by pulling chains.

There are automotive insurance companies that offer the service to charge an EV when it runs out of power. Their systems are usually made of big batteries and big inverters that are loaded on trailers or trunks of big pick-ups that will deliver energy to the EVs. Their main problem is the waiting time, difficulty to access remote areas, and all the fees this service includes. Customers have to wait until the insurance company arrives, plus the time it takes the EV battery to have enough charge to go to the closest charging station. Another aspect to analyze is that running the EV out of power will damage its battery and reduce its span life. Therefore, a need exists for an Emergency On-Board EV Charger (EOBC).

### OBJECTS OF INVENTION

A primary object of the present invention is a portable EV charger designed to charge an EV in case of an emergency (when the EV is running out of battery), extending the EV range.

Another object of the present invention is to provide a modular on-board EV charger that can be easily and safely placed in the trunk of any EV.

A secondary object of the present invention is to be a portable power station to deliver energy to small appliances.

### BRIEF SUMMARY OF THE INVENTION

The present invention overcomes the shortcomings of the prior art by placing an On-Board charger in the trunk of any EV. The emergency charger is safely and easily placed in the trunk due to its compact design. When using the EOBC for one hour, it can deliver between 5 to 40 miles of extra range depending on the EV battery size and the capacity of the EOBC. A novel design of a modular high power compact Li-ion battery pack and a high power compact true sine inverter are the main components of the invention. The EOBC is EV agnostic in that it allows any EV in the market to be charged. It will be placed at the trunk of the EV but is light enough to be carried around by a single person, and it only needs to be charged when used. It has a smartphone app so the user can monitor current, voltage, SOC, temperature, when the EOBC needs to be charged, or how much power is left when it is being used. It has several safety protections against short circuits, overloads, critical temperatures, and other safety measures such as a sturdy case, Battery Management System (BMS), and fire extinguishers.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A illustrates an oblique front view of a general battery module with its front and top covers removed, according to certain embodiments of the invention.

FIG. 1B illustrates an oblique front view of a general battery module, according to certain embodiments of the invention.

FIG. 1C illustrates an oblique back view of a general battery module, according to certain embodiments of the invention.

FIG. 2A illustrates an oblique front view of a general pure sine inverter, according to certain embodiments of the invention.

FIG. 2B illustrates an oblique back view of a general pure sine inverter, according to certain embodiments of the invention.

FIG. 3A illustrates an oblique front view of the EOBC, according to certain embodiments of the invention.

FIG. 3B illustrates an oblique back view of the EOBC, according to certain embodiments of the invention.

FIG. 3C illustrates an oblique front view of the EOBC with two battery modules, according to certain embodiments of the invention.

FIG. 3D illustrates an oblique back view of the EOBC with two battery modules, according to certain embodiments of the invention.

FIG. 4A illustrates an oblique front view of the EOBC connected to an EV, according to certain embodiments of the invention.

FIG. 4B illustrates an oblique back view of the EOBC with two battery modules connected to an EV, according to certain embodiments of the invention.

### DETAILED DESCRIPTION OF THE INVENTION

The present disclosure relates to an Emergency On-Board EV Charger (EOBC). More particularly, the present disclosure relates to the technology employed by EOBC. The EOBC is composed of multiple components that are interconnected, mainly by a lithium battery module and pure sine inverter.

Aspects of the present inventions are described below in detail to specific aspects or features with certain examples illustrated in the accompanying drawings. Wherever possible, corresponding or similar reference numbers will be used throughout the drawings to refer to the same or corresponding parts.

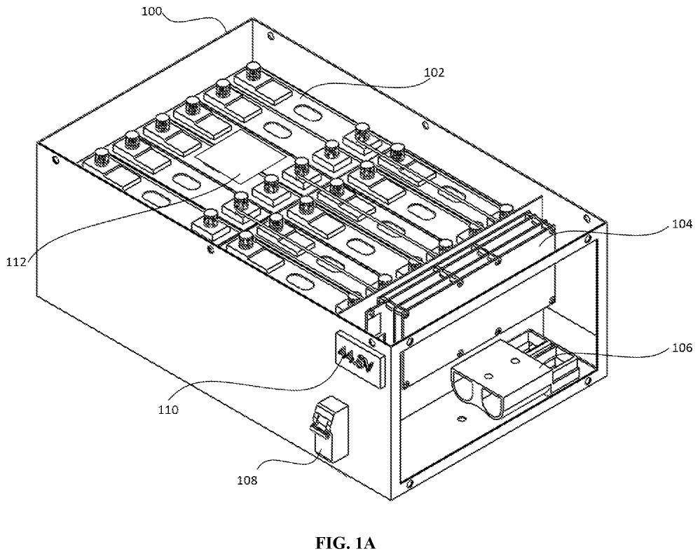

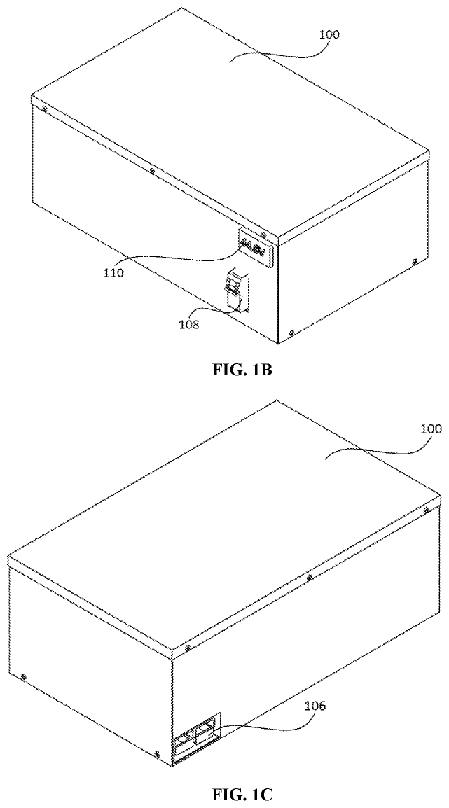

FIG. 1 illustrates a general lithium battery module 100 in an oblique front view with its front and top covers removed through FIG. 1A, in an oblique front view through FIG. 1B, and in an oblique back view through FIG. 1C. With combined reference to FIGS. 1A, 1B and 1C, the battery module 100 may be made from any lithium chemistry of a conventional battery cell 102, but all the cells 102 inside the battery module 100 must have the same chemistry, SOH, capacity and discharge rate. The module 100 can be formed by a different number of cells 102 in series and/or parallel in order to deliver enough power when charging an EV, giving as a result a battery module 100 with different voltage, current, size and form factor. Cell chemistry, weight and size are crucial in order to afford a compact, portable, and light battery module.

FIG. 1A shows all the internal elements that the lithium battery module 100 has, including the battery cells 102, the Battery Management System (BMS) 104, battery output connector 106, breaker switch 108, voltage display 110 and built-in fire extinguisher 112. The BMS 102 is the main controller of the lithium battery module 100, it is in charge of balancing the cells 102, acting as a switch between the Li-Ion battery module 100 and the system to protect the battery cells 102 from operating in unfavorable conditions (over current, over voltage, under voltage, high temperature, low temperature, short circuits), and it has a smartphone app so the user can monitor current, voltage, SOC, temperature, when the EOBC needs to be charged, or how much power is left when it is being used.

The lithium battery module 100 has a strong metal box shape in order to protect the battery cells 102 from any uncontrolled and variable conditions. The breaker switch 108 is designed to turn on the lithium battery module 100, to protect the battery 100 from short circuits, over current and over temperatures; while the voltage display 110 shows the actual voltage when the battery module 100 is On as illustrated on FIG. 1B. On FIG. 1C, the battery output connector 106 is displayed with more detail. It is designed as a plug and play connector, so the positive and negative DC terminals of the battery can be connected to the appropriate positive and negative cables that will be connected to the pure sine inverter terminals 204 or to a lithium battery charger.

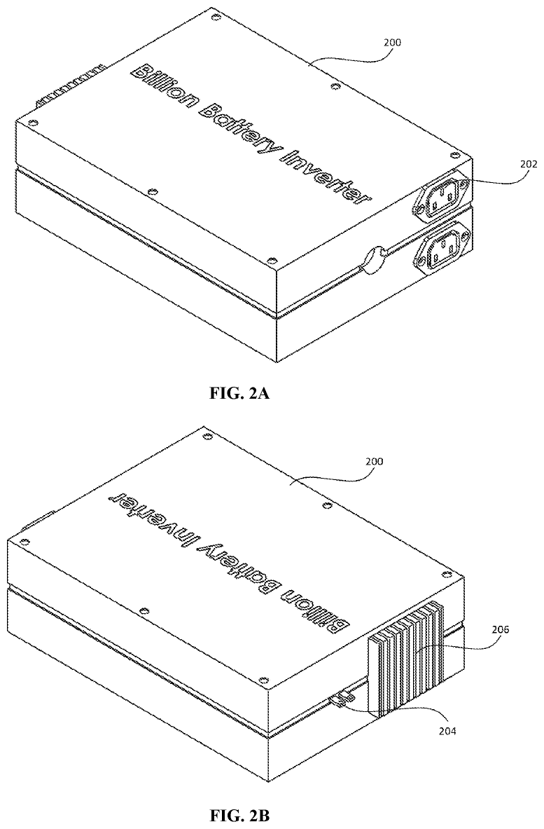

FIG. 2 illustrates a general pure sine inverter 200 in an oblique front view of through FIG. 2A, and in an oblique back view through FIG. 2B. The inverter has a metal shape structure to ensure the protection of its internal components. The inverter AC output 202 delivers energy to the EV charger port when charging the EV while the DC terminals 204 are powered by the lithium battery module 100 and the smart fan 206 regulates the internal temperature of the inverter.

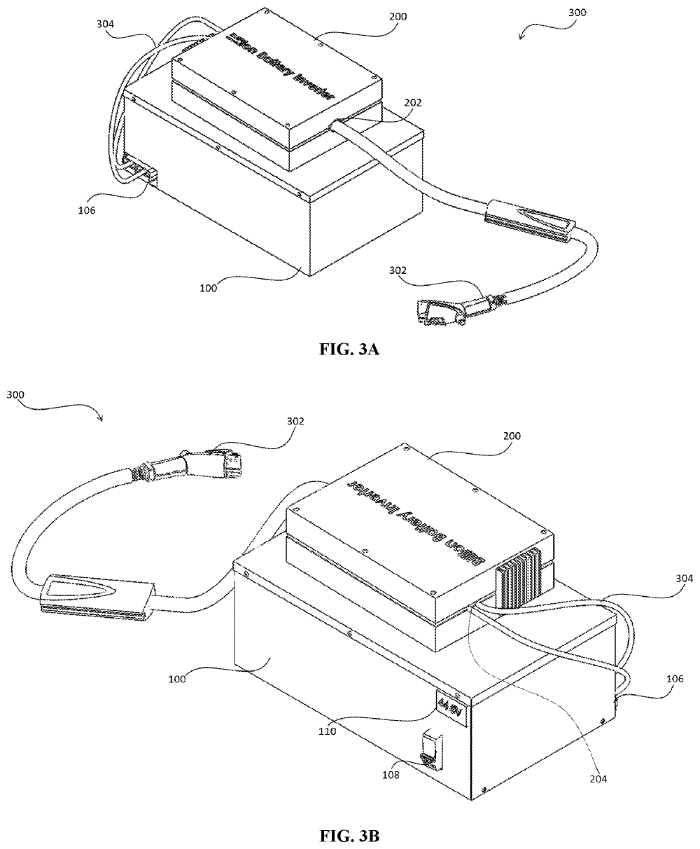

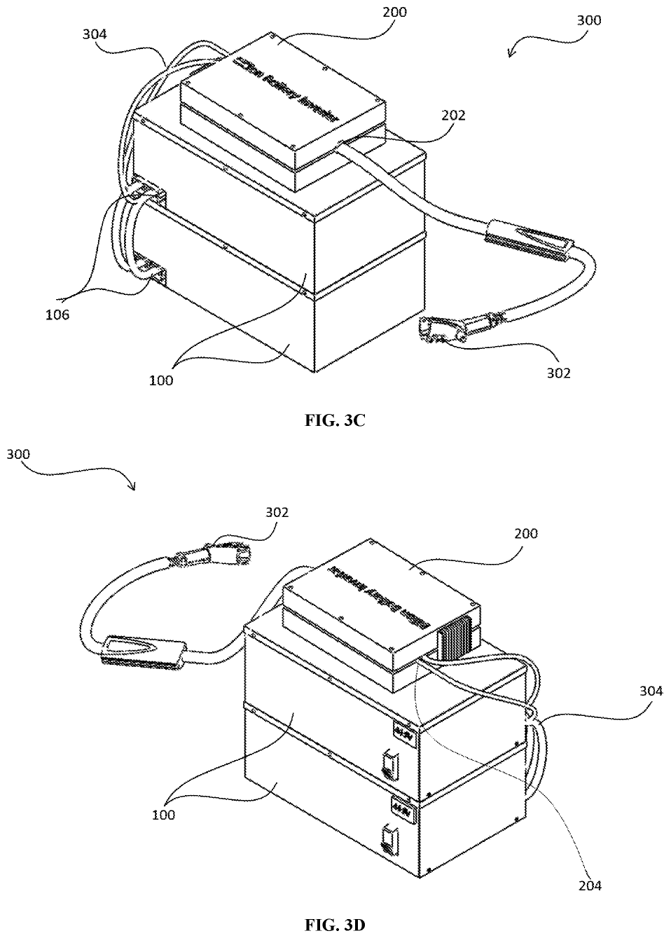

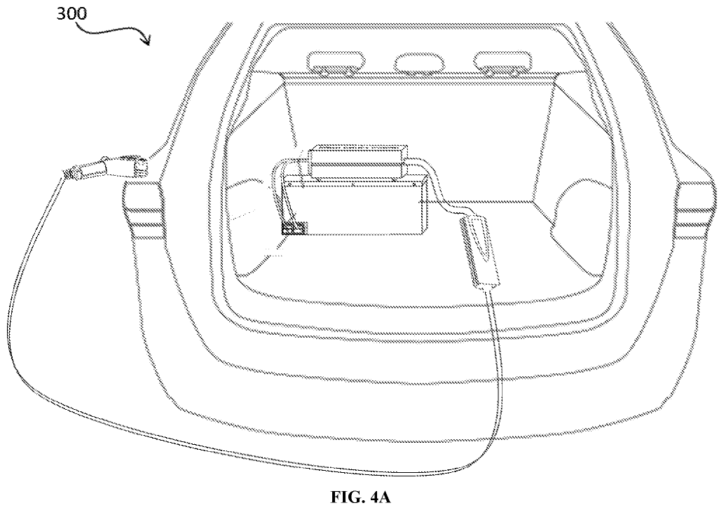

FIG. 3 illustrates a level 1 EOBC 300 in an oblique front view of through FIG. 3A, and in an oblique back view through FIG. 3B, and a level 2 EOBC 300 in an oblique front view of through FIG. 3C, and in an oblique back view through FIG. 3D.

Level 1 EOBC 300 is composed of a singular lithium battery module 100, a 110 V pure sine inverter 200 and a level 1 EV charger (110 V) 302 as illustrated on FIGS. 3A & 3B. The battery module 100 is connected to the inverter 200 by plugging the battery cables 304 to the battery output connector 106 and the DC terminals 204. The level 1 EV charger 302 is connected to the inverter AC output connector 202.

Level 2 EOBC 300 is composed of a pair of lithium battery modules 100, a 220 V pure sine inverter 200 and a level 2 EV charger (220 V) 302 as illustrated on FIGS. 3C & 3D. The battery modules 100 are connected to the inverter 200 by plugging the battery cables 304 to the battery output connectors 106 and the DC terminals 204. The level 2 EV charger 302 is connected to the inverter AC output connector 202.

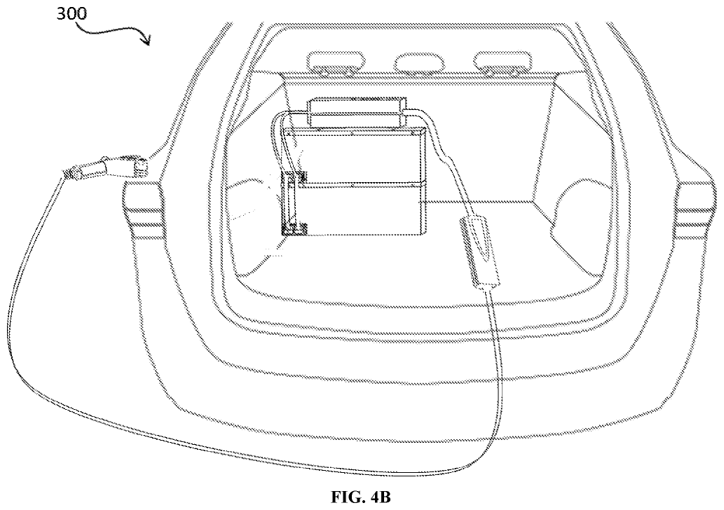

FIG. 4 illustrates the EOBC 300 placed inside an EV trunk in a front view through FIGS. 4A and 4B. Level 1 EOBC 300 safely placed inside an EV trunk and connected to the EV charging port is shown on FIG. 4A. Level 2 EOBC 300 safely placed inside an EV trunk and connected to the EV charging port is shown on FIG. 4B.

What is claimed is:

1. A universal emergency on-board electric vehicle charger comprising:
a. modular battery housing;
b. battery management system;
c. smartphone app monitoring system;
d. pure sine inverter;
e. sturdy case;
f. built-in fire extinguisher;
g. AC output connector; and
h. EV charger adapter.

2. The universal emergency on-board electric vehicle charger as in claim 1, wherein the modular battery housing allows for the on-board electric vehicle charger to be aligned by itself or in either series or parallel.

3. The universal emergency on-board electric vehicle charger as in claim 1, wherein the battery management system protects against overloads, critical temperatures, and short circuits.

4. The universal emergency on-board electric vehicle charger as in claim 1, wherein the smartphone app monitoring system allows the user to track current, voltage, SOC, temperature, and the current charge on the emergency on-board electric vehicle charger.

5. The universal emergency on-board electric vehicle charger as in claim 1, wherein the pure sine inverter transfers 110V/220V.

6. The universal emergency on-board electric vehicle charger as in claim 1, wherein the sturdy case is designed to fit inside of any EV and be light enough to be carried by a single person.

7. The universal emergency on-board electric vehicle charger as in claim 1, wherein the built-in fire extinguisher deploys in the event of a fire.

8. The universal emergency on-board electric vehicle charger as in claim 1, wherein AC output connector is connected to the EV charger adapter, and this is connected to the EV charging port.

9. A method of manufacturing a universal emergency on-board electric vehicle charger comprising:
a. modular battery housing;
b. battery management system;
c. smartphone app monitoring system;
d. pure sine inverter;
e. sturdy case;
f. built-in fire extinguisher; and
g. AC output connector.

10. A method of manufacturing the universal emergency on-board electric vehicle charger as in claim 9, wherein the modular battery housing allows for the on-board electric vehicle charger to be aligned by itself or in either series or parallel.

11. A method of manufacturing the universal emergency on-board electric vehicle charger as in claim 9, wherein the battery management system protects against overloads, critical temperatures, and short circuits.

12. A method of manufacturing the universal emergency on-board electric vehicle charger as in claim 9, wherein the smartphone app monitoring system allows the user to track current, voltage, SOC, temperature, and the current charge on the emergency on-board electric vehicle charger.

13. A method of manufacturing the universal emergency on-board electric vehicle charger as in claim 9, wherein the pure sine inverter transfers 110/220V.

14. A method of manufacturing the universal emergency on-board electric vehicle charger as in claim 9, wherein the sturdy case is designed to fit inside of any EV and be light enough to be carried by a single person.

15. A method of manufacturing the universal emergency on-board electric vehicle charger as in claim 9, wherein the built-in fire extinguisher deploys in the event of a fire.

16. A method of manufacturing the universal emergency on-board electric vehicle charger as in claim 9, wherein the AC output connector is connected to the EV charger adapter, and this is connected to the EV charging port.
